(19) United States
(12) Patent Application Publication
(10) Pub. No.: US 2014/0368757 A1
(43) Pub. Date: Dec. 18, 2014

(54) TOUCH PANEL

(71) Applicant: Wintek Corporation, Taichung City (TW)

(72) Inventors: Hsuan-Yang CHEN, Hua Lien County (TW); Yi-Hsuan HUANG, Tai Chung City (TW); Tzung-Fu LAI, Tai Chung City (TW)

(21) Appl. No.: 14/305,664

(22) Filed: Jun. 16, 2014

(30) Foreign Application Priority Data
Jun. 14, 2013 (TW) 102121192

(51) Int. Cl. G06F 3/041

(52) U.S. Cl. CPC G06F 3/041
USPC 349/12

(57) ABSTRACT

A touch panel includes a substrate, a buffer layer, an appearance decoration layer, a touch-sensing element, and a plurality of transmission lines. The buffer layer is formed on and in contact with the substrate, and the buffer layer and the substrate are formed from mutual different materials to have different surface adhesions. The appearance decoration layer is disposed on a periphery of the substrate, and the touch-sensing element is formed on and in contact with the buffer layer. The touch-sensing element includes a plurality of capacitive coupling pads, and at least one of the capacitive coupling pads covers a part of the appearance decoration layer. The transmission lines are disposed on the appearance decoration layer and electrically connected to the touch-sensing element.

### BACKGROUND OF THE INVENTION

1. Field of the Invention

The invention relates to a touch panel.

2. Description of Related Art

Typically, a touch panel may have a plurality of transmission lines connected with a touch-sensing element to transmit signals. In order to reduce transmission impedance, the transmission lines are often formed from a visible metallic material, and thus a black light-shielding material is needed to shield the transmission lines from being seen. Further, the transmission lines are usually disposed at a peripheral area of the touch panel to maximize an effective display area. Therefore, a black decorative frame is formed to hide the transmission lines.

However, the current trend is towards the use of a non-black decorative frame to allow for a wide diversity of appearances of a touch panel to satisfy individual needs of consumers. Since a non-black decorative layer formed from a non-black material has poor shielding effects, a low light-transmittance layer (such as a black ink layer) is often used and disposed in contact with the non-black decorative layer to reinforce the shielding effects. However, the appearance of a touch panel may thus become worse since the low light-transmittance layer may interact with the non-black decorative layer to result in color shift on the non-black decorative layer. For example, a chemical reaction may occur between the low light-transmittance layer and the non-black decorative layer to cause the non-black decorative layer to become impure or yellow in color. Besides, since a touch panel is liable to suffer external impacts, there is a great need to enhance the impact resistance on a touch panel.

### SUMMARY OF THE INVENTION

Accordingly, the invention provides a touch panel with a non-black decorative region having improved shielding effects and reliability.

According to an embodiment of the invention, a touch panel includes a substrate, an appearance decoration layer disposed on a periphery of the substrate, a touch-sensing element disposed on the substrate, a plurality of transmission lines and a buffer layer. The touch-sensing element includes a plurality of first capacitive coupling units, a plurality of second capacitive coupling units spaced apart from the first capacitive coupling units, and a plurality of insulators separate from each other. Each of the first capacitive coupling units comprises multiple first pads and multiple first connection lines, the first pads are connected with each other by the first connection lines, and at least one of the first pads overlaps the appearance decoration layer. The second capacitive coupling units and the first capacitive coupling units are oriented to cross over each other at crossover locations, each of the second capacitive coupling units comprises multiple second pads and multiple second connection lines, the second pads are connected with each other by the second connection lines, and at least one of the second pads overlaps the appearance decorative layer. The insulators are disposed in the crossover locations to separate the first capacitive coupling units and the second capacitive coupling units at each of the crossover locations. The transmission lines are disposed on the substrate, shielded by the appearance decoration layer, and electrically connected to the touch-sensing element. The buffer layer is formed on the substrate and at least interposed between the touch-sensing element and the substrate to change at least one mechanical property of a combination of the touch-sensing element and the substrate.

In one embodiment, a part of the buffer layer is located between the transmission lines and the appearance decoration layer.

In one embodiment, the buffer layer is an optical matching layer with a refractive index matching with a refractive index of the touch-sensing element.

In one embodiment, a light-shielding layer is disposed on one side of the appearance decoration layer facing away from the substrate, and an optical density of the light-shielding layer is greater than an optical density of the appearance decoration layer.

In one embodiment, the buffer layer is formed from an organic material, a mixture of organic and inorganic materials, or a hybrid compound of organic and inorganic materials.

In one embodiment, a part of the buffer layer is located between and in contact with the appearance decoration layer and the substrate.

In one embodiment, the buffer layer has a first part disposed on a first side of the appearance decoration layer and a second part disposed on a second side of the appearance decoration layer opposite the first side, and the first part and the second part are formed from mutually different materials.

According to another embodiment of the invention, a touch panel includes a substrate, a buffer layer, an appearance decoration layer, a touch-sensing element, and a plurality of transmission lines. The buffer layer is formed on and in contact with the substrate, wherein the buffer layer and the substrate are formed from mutual different materials to have different surface adhesions. The appearance decoration layer is disposed on a periphery of the substrate, and the touch-sensing element is formed on and in contact with the buffer layer. The touch-sensing element includes a plurality of capacitive coupling pads, and at least one of the capacitive coupling pads covers a part of the appearance decoration layer. The transmission lines are disposed on the appearance decoration layer and electrically connected to the touch-sensing element.

In one embodiment, the buffer layer is a transparent insulation layer, and a refractive index of the buffer layer is different to refractive indexes of the substrate and the touch-sensing element.

In one embodiment, the buffer layer substantially surrounds the appearance decoration layer.

According to an embodiment of the invention, a touch panel includes a substrate, a buffer layer, an appearance decoration layer, a touch-sensing element, and a plurality of transmission lines. The buffer layer is formed on and in contact with the substrate, and the buffer layer comprises organic material. The appearance decoration layer is disposed on a periphery of the substrate, and the touch-sensing element is formed on and in contact with the buffer layer. The touch-sensing element includes a plurality of first capacitive coupling units, a plurality of second capacitive coupling units spaced apart from the first capacitive coupling units, and a plurality of insulators separate from each other. Each of the first capacitive coupling units comprises multiple first pads and multiple first connection lines, the first pads are connected with each other by the first connection lines, and at least one of the first pads overlaps the appearance decoration layer. The second capacitive coupling units and the first capacitive coupling units are oriented to cross over each other at crossover locations, each of the second capacitive coupling units comprises multiple second pads and multiple second connection lines, the second pads are connected with each other by the second connection lines, and at least one of the second pads overlaps the appearance decorative layer. The transmission lines are disposed on the appearance decoration layer and electrically connected to the touch-sensing element.

In one embodiment, wherein at least one of the first pads covers a part of one of the insulators.

In one embodiment, wherein a lateral side of at least one of the insulators is not aligned with a lateral side of one of the first connection lines under the insulator to expose a part of the first connection line, and one of the first pads covers the exposed part of the first connection line and touches the lateral side of the insulator, the lateral side of the first connection line, and the exposed part of the first connection line.

According to the above embodiments, the buffer layer is allowed to change at least one mechanical property of a conjunction of neighbouring elements or a decorative cover plate to achieve beneficial effects. For example, in case the buffer layer is interposed between the touch-sensing element and the substrate, the buffer layer may naturally serve as a cushion layer to resist impact knocking on the substrate, or the material characteristic of the buffer layer may increase toughness of a combination of the touch-sensing element and the substrate to reduce the risk of break on suffering external impacts. Further, in case the buffer layer and the substrate are formed from different materials, it may open a possibility where surface adhesion of the buffer layer is higher compared with the substrate to develop a stronger attachment to the touch-sensing element that is formed on and in contact with the buffer layer. Besides, in case the buffer layer is designed to have a selected range of refractive index, the buffer layer may serve as an optical matching layer that matches with refractive indexes of adjacent layers in the transparent region to improve the overall transmittance of the touch panel and reduce the visibility of the touch-sensing element. Moreover, the buffer layer may be disposed between the appearance decoration layer and the light-shielding layer to alleviate or eliminate the penetrating phenomenon of the light-shielding layer to keep the original color of the appearance decoration layer, and thus makes the displayed color of the light-shielding region have improved saturation. In addition, the appearance decoration layer allows the touch panel to have a non-black decorative color, and the lack of shielding effects of the appearance decoration layer may be compensated for by the formation of the light-shielding layer.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1A shows a top view of a touch panel according to an embodiment of the invention.

FIG. 1B shows a cross-sectional diagram of FIG. 1A cut along line I-I.

FIG. 1C shows a partial cross-sectional diagram of a touch panel according to another embodiment of the invention.

FIG. 1D shows a partial cross-sectional diagram of a touch panel according to another embodiment of the invention.

FIG. 2 is a diagram showing the stacked layers in the light-shielding region of a touch panel according to an embodiment of the invention.

FIG. 3 is a diagram showing the stacked layers in the light-shielding region of a touch panel according to another embodiment of the invention.

FIG. 4 is a diagram showing the stacked layers in the light-shielding region of a touch panel according to another embodiment of the invention.

FIG. 5A is a partial cross-sectional diagram of a touch panel according to another embodiment of the invention.

FIG. 5B is a partial cross-sectional diagram of a touch panel according to another embodiment of the invention.

FIG. 6 is a partial cross-sectional diagram in the light-shielding region of a touch panel according to another embodiment of the invention.

### DESCRIPTION OF THE EMBODIMENTS

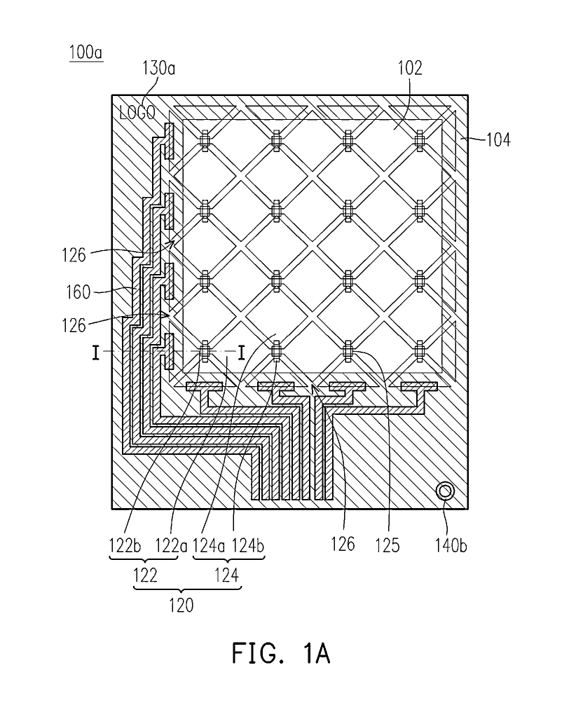

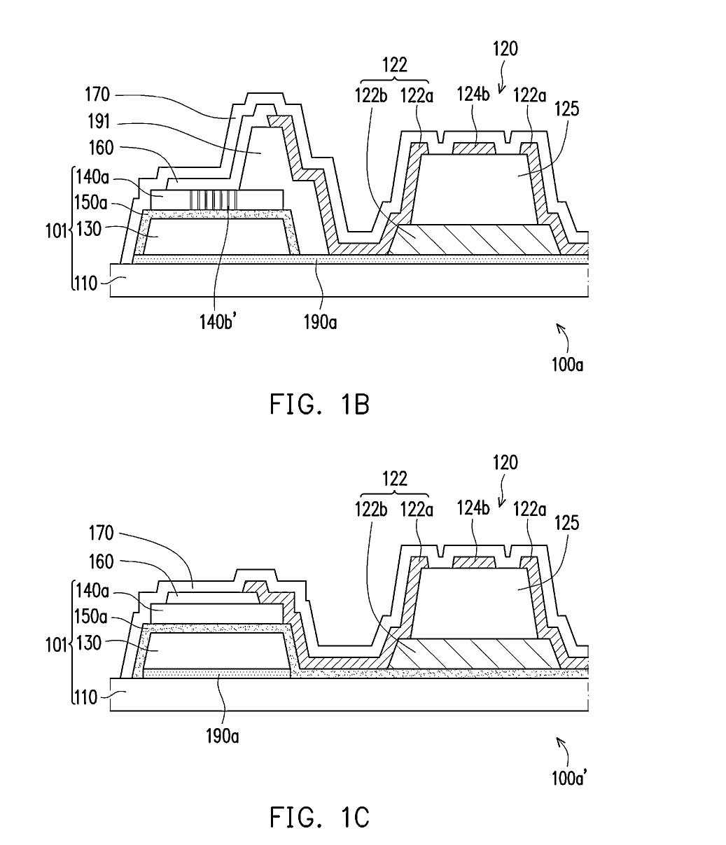

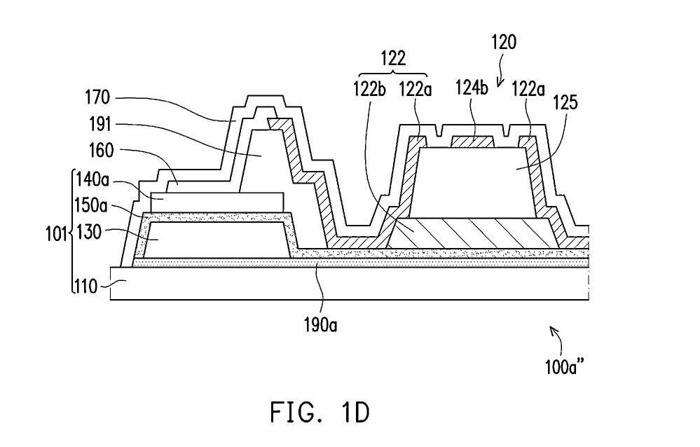

FIG. 1A is a top-view of a touch panel according to an embodiment of the invention and FIG. 1B is a cross-sectional diagram of FIG. 1A cut along line I-I. Referring to FIGS. 1A and 1B, in the present embodiment, a touch panel 100a includes a decoration cover plate 101, a touch-sensing element 120, a plurality of transmission lines 160 and a protection layer 170. The decoration cover plate 101 includes a substrate 110, an appearance decoration layer 130, a light-shielding layer 140a and a buffer layer 150a. For an electronic device having both a display function and a touch function, the touch panel 100a may have a transparent region 102 and a light-shielding region 104 located on at least one side of the transparent region 102. The transparent region 102 may be disposed correspondingly to a display element (for example, a liquid crystal display element or an organic light emitting diode display element) or other light source, and the light-shielding region 104 may be disposed correspondingly to elements needed to be hidden, such as the visible transmission lines 160. In order to maximize an effective display area of an electronic device, the current trend is toward a narrow border frame. Thus, the visible transmission lines 160 are usually disposed on a periphery of the touch panel 100a, or may be further disposed on only one side of the touch panel 100a. Similarly, the light-shielding region 104 may be disposed on at least one side of the touch panel 100a overlapping the appearance decoration layer 130 or the light-shielding layer 140a. Both the appearance decoration layer 130 and the light-shielding layer 140a may be formed from a light resistant material, where the light resistant material is defined as a material that causes at least certain light loss when light passes therethrough and is used to hide an element or shield undesired light beams in an electronic device.

Moreover, the substrate 110 may be a rigid transparent substrate or a flexible transparent substrate formed from glass or plastic. Further, the substrate 110 may be formed from a transparent insulation material including, but not limited to, a chemically strengthened glass, a polarizer (linear or circular) coated with a hard coat layer, a composite laminate composed of poly (methyl methacrylate) (PMMA) and polycarbonate (PC), an ultraviolet curable resin material (such as ORGA resin), or any other rigid transparent insulation material having protection properties like anti-scratch and high mechanical strength. Further, any other suitable optical layer like an anti-glare layer or an antireflection layer may be disposed on a surface of the substrate 110 facing away from the light-shielding layer 140a. The thickness and hardness of an optical layer may be less than the thickness and hardness of the substrate 110. The thickness of the substrate 110 may be in the range of 0.2 to 2 mm. When a user looks at the touch panel 100a, the light-shielding region 104, is given a color identical to the color of the appearance decoration layer 130. In the present embodiment, the light-shielding region 104 is disposed on a periphery of the substrate 110, and the light-shielding layer 140a is disposed on one side of the appearance decoration layer 130 facing away from the viewing side. The optical density (OD) of the light-shielding layer 140a is greater than the optical density (OD) of the appearance decoration layer 130 to provide sufficient light-shielding effects to hide elements in the light-shielding region 104. In the present embodiment, the light-shielding layer 140a may coincide with the transmission line 160 in position to entirely hide the transmission lines 160. In one embodiment, the light-shielding layer 140a may have a color with low brightness such as black, grey, blue, purple or silver, and the appearance decoration layer 130 may have a color with high brightness such as white, pink or Naples yellow. In one embodiment, the OD of the light-shielding layer 140a with a thickness of 1 micrometer may be in the range of 3 to 4, and the OD of the appearance decoration layer 130 with a thickness of 20 micrometers may be in the range of 0.8 to 0.9. In an alternate embodiment, the appearance decoration layer 130 may be made of a material with an OD less than 3 or a material with an OD less than the OD of the transmission lines 160, and the light-shielding layer 140a may be made of a material with an OD greater than the OD of the appearance decoration layer 130. Therefore, the OD of the light-shielding layer 140a may be larger than 4.

In one embodiment, the light-shielding region 104 may have an icon 130a seen by an user, such as text, a trademark, a decorative pattern, a function key, and so forth. Referring to FIGS. 1A and 1B again, a portion of the light-shielding layer 140a may be hollowed out to form a transparent pattern 140b. For example, the light-shielding layer 140a may have a plurality of through holes 140b′ arranged in a specific order to constitute the transparent pattern 140b, and a luminous image appears when light passes through the through holes 140b′.

The material of the appearance decoration layer 130 may include ceramic, an organic material, a mixture of organic and inorganic materials, or a hybrid compound of organic and inorganic materials, and the appearance decoration layer 130 may be a single-layer structure or a multi-layer structure formed from the same material or different materials. The thickness of the appearance decoration layer 130 may be in the range of 0.5 to 50 micrometers. In one embodiment, the material of the appearance decoration layer 130 may be a photosensitive resin (e.g., photoresist) or a non-photosensitive resin (such as ink), and the material of the light-shielding layer 140a may include metal, metal compounds, ceramic, diamond-like carbon, an organic material, a mixture of organic and inorganic materials or a hybrid compound of organic and inorganic materials. For example, the material of the light-shielding layer 140a may include chromium, aluminium, silver, copper, gold, titanium, tungsten, molybdenum, zinc, or compounds thereof. Alternatively, the material of the light-shielding layer 140a may be a photosensitive resin or a non-photosensitive resin (such as ink or other light-absorbing resin), where the thickness of the light-shielding layer 140a may be in the range of 0.3 to 20 micrometers.

In one embodiment, the buffer layer 150a is disposed between the appearance decoration layer 130 and the light-shielding layer 140a. The material of the buffer layer 150a may be different from the materials of the appearance decoration layer 130 and the light-shielding layer 140a. The buffer layer 150a may serve a function of preventing the light-shielding layer 140a from affecting the color hue of the appearance decoration layer 130 to remedy possible defects in the color performance of the appearance decoration layer 130, such as color shift, yellowing or unexpected dirty color. The transmission lines 160 are disposed on one side of the light-shielding layer 140a facing away from the substrate 110 and electrically connected to the touch-sensing element 120. The protection layer 170 is disposed on one side of the visible transmission lines 160 facing away from the substrate 110 and at least covers the touch-sensing element 120 and the transmission lines 160. In one embodiment, the protection layer 170 may be a continuous layer covering the entire transparent region 102 and the transmission lines 160 in the light-shielding region 104. The protection layer 170 may be made of an insulation material, such as silicon dioxide, silicon nitride, other inorganic insulation material, or an organic insulation material. In one embodiment, the thickness of the protection layer 170 may be at least 0.8 micrometers to reduce a height difference between the light-shielding region 104 and the transparent region 102. In an alternate embodiment, the protection layer 170 may also serve a function of anti-reflection, and the protection layer 170 may be a dual-layer structure composed of silicon dioxide (SiO₂) and silicon nitride (SiNₓ) to improve the overall transmittance of the touch panel 100a and reduce the visibility of the touch-sensing element 120.

Referring to FIGS. 1A and 1B, in this embodiment, the touch-sensing element 120 disposed on the substrate 110 includes a plurality of first capacitive coupling units 122 and a plurality of second capacitive coupling units 124, where the second capacitive coupling units 124 and the first capacitive coupling units 122 are oriented to cross over each other at crossover locations, and the first capacitive coupling units 122 are insulated from the second capacitive coupling units 124. The terminal of each first capacitive coupling unit 122 is connected with a corresponding transmission line 160, and the terminal of each second capacitive coupling unit 124 is connected with a corresponding transmission line 160. The touch-sensing element 120 is mainly disposed in the transparent region 102, and a part of the touch-sensing element 120 is disposed in the light-shielding region 104. That is, the touch-sensing element 120 across the transparent region 102 may terminate at the light-shielding region 104. Accordingly, an effective touch-sensing region is wider than the transparent region 102, and the touch sensitivity at an interface of the transparent region 102 and the light-shielding region 104 may be equal to the touch sensitivity in the transparent region 102. The touch-sensing element 120 may be formed from invisible conductive material, such as indium tin oxide (ITO), indium-zinc oxide (IZO), gallium zinc oxide (GZO), carbon nanotube-based thin films, metal nanowires, or other high conductive materials having an invisible linewidth. In one embodiment, the metal nanowires may be silver nanowires, and the invisible linewidth may be a linewidth of a metal wire less than 10 μm. Each of the first capacitive coupling unit 122 includes a plurality of first capacitive coupling pads 122a connected by a plurality of first connection lines 122b, and each of the second capacitive coupling unit 124 includes a plurality of second capacitive coupling pads 124a connected by a plurality of second connection lines 124b. The first capacitive coupling pads 122a and second capacitive coupling pads 124a are not overlapped and separated by insulation gaps 126 therebetween, and the first capacitive coupling unit 122 and the second capacitive coupling unit 124 are also separated by the insulation gaps 126 therebetween. A plurality of insulators 125 are disposed between the first connection lines 122b and the second connection lines 124b (in the crossover locations) and separate from each other, so that each first connection line 122b covered by the insulators 125 is overlapped with and insulated from a corresponding second connection line 124b. As can be clearly seen in FIG. 1B, in one embodiment, at least one of the capacitive coupling pads 122a covers a part of one of the insulators 125, a lateral side of at least one of the insulators 125 is not aligned with a lateral side of one of the first connection lines 122b under the insulator 125 to expose a part of the first connection line 122b, and one of the first capacitive coupling pads 122a covers the exposed part of the first connection line 122b and touches the lateral side of the insulator 125, the lateral side of the first connection line 122b, and the exposed part of the first connection line 122b. Further, at least one insulation pattern 191 may be disposed between the touch-sensing element 120 and the appearance decoration layer 130. In an alternate embodiment, a plurality of discontinuous insulation patterns (not shown) may be optionally disposed on the appearance decoration layer 130 at a position corresponding to the insulation gaps 126 and partially overlapping the touch-sensing element 120 to ensure the dielectricity of the insulation gaps 126. When a conductive object such as a finger approaches to or touches a touch-sensing surface of the substrate 110 facing away from touch-sensing element 120, the conductive object may attract some of fringing electric field lines formed in the touch-sensing element 120 and effect a change in the mutual capacitance that can be detected to recognize touch positions.

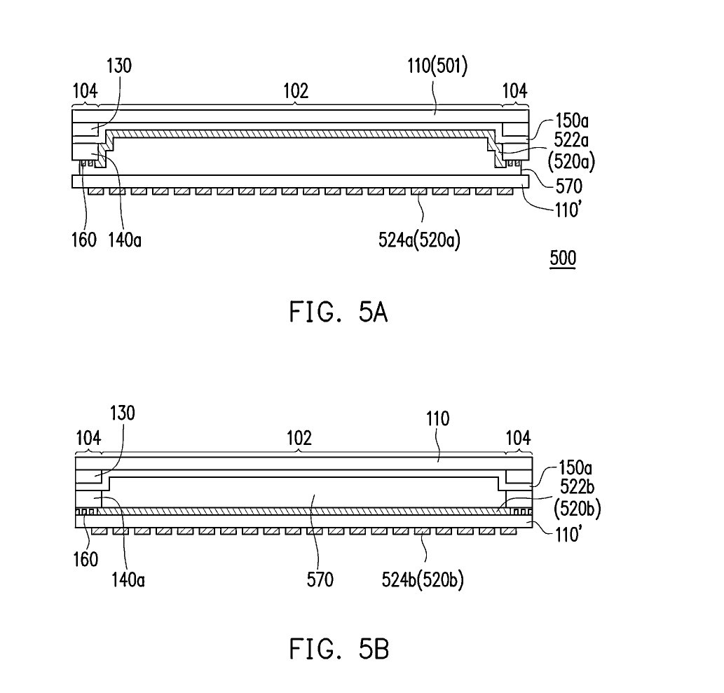

In one embodiment, the touch-sensing element may be disposed on a substrate of a decoration cover plate. The touch-sensing element may include a plurality of first capacitive coupling units, a plurality of second capacitive coupling units and a plurality of transmission lines, and the above-mentioned elements are formed on the same side of the substrate. The first capacitive coupling unit and the second capacitive coupling unit are separate from and not overlapped with each other. Each of the first capacitive coupling unit or the second capacitive coupling unit may include a plurality of capacitive coupling pads, each of the transmission lines is electrically connected to the first capacitive coupling unit and the second capacitive coupling unit, and the first capacitive coupling unit and the second capacitive coupling unit are insulated from each other. A part of the transmission lines is disposed in the transparent region 102 and terminates at the light-shielding region 104. In the transparent region 102, the transmission lines may be made of invisible conductive material such as indium tin oxide (ITO), indium-zinc oxide (IZO), gallium zinc oxide (GZO), carbon nanotube-based thin films, metal nanowires, or other high conductive materials having an invisible linewidth. In one embodiment, the metal nanowires may be silver nanowires, and the invisible linewidth may be a linewidth of a metal wire less than 10 μm. In the light-shielding region 104, the transmission lines may include visible conductive material to reduce transmission impedance, or may be connected with a visible circuit board. In another embodiment, as shown in FIG. 5A, a touch-sensing element 520a of a touch panel 500 includes a plurality of first capacitive coupling unit 522a and a plurality of second capacitive coupling unit 524a, the first capacitive coupling units 522a are disposed on a substrate 110 of a decoration cover plate 501, and the second capacitive coupling units 524a are disposed on an insulation base 110′. The substrate 110 and the insulation base 110′ are adhered to each other by an adhesive layer 570. The buffer layer 150a is a continuous layer disposed between the appearance decoration layer 130 and the light-shielding layer 140a and between the substrate 110 and the first capacitive coupling units 522a. The first capacitive coupling units 522a and the second capacitive coupling units 524a are insulated from each other. The insulation base 110′ may be a resin film or a glass substrate having a thickness less than the substrate 110.

In an alternate embodiment shown in FIG. 5B, a touch-sensing element 520b of a touch panel 500 includes a plurality of first capacitive coupling units 522b and a plurality of second capacitive coupling units 524b, the first capacitive coupling units 522b and the second capacitive coupling units 524b are disposed on two opposite sides of the insulation base 110′, and the transmission lines 160 are disposed on the insulation base 110′ and electrically connected to the touch-sensing element 520b. In the present embodiment, no touch-sensing element is formed on the decoration cover plate 501, but the decoration cover plate 501 is still required to protect the touch-sensing element 520b, hide the internal visible element, and serve as a touch-sensing interface for a user. The decoration cover plate 501 is adhered to the insulation substrate 110′ through the adhesive layer 570. In addition, the touch-sensing element may be other suitable structure and not limited to a projected capacitive-type structure illustrated in above embodiments. For example, the touch-sensing element may include a plurality of conductive lines with a fixed width. Moreover, the capacitive coupling pads may be, but not limited to, in the shape of a diamond, a triangle, a snowflake or a line segment.

The buffer layer 150a may be formed from an insulation material including an organic material such as a photosensitive resin or a non-photosensitive resin, an inorganic insulation material, a mixture of organic and inorganic insulation materials or a hybrid compound of organic and inorganic insulation materials. The buffer layer 150a may be transparent or may have a color hue to allow visible light to pass therethrough. Further, the buffer layer 150a may be a single-layer structure or a multi-layer structure, and the multi-layer structure may be formed form the same material or different materials. The buffer layer 150a formed from an organic material may have a thickness preferably in the range of 0.01 to 10 micrometers and a refractive index preferably in the range of 1.2 to 2. The buffer layer 150a formed from an inorganic dielectric material may include nitride or oxide, such as silicon oxide, titanium oxide, silicon nitride and titanium nitride, and have a thickness preferably in the range of 0.001 to 10 micrometers and a refractive index preferably in the range of 1.2 to 2. The buffer layer 150a with a color may include resin and pigment. For example, the colored buffer layer 150a may be a white ink layer and preferably has a thickness in the range of 0.5 to 100 micrometers.

The buffer layer 150a may be formed from a transparent material and may continuously spread over both the light-shielding region 104 and the transparent region 102. For example, as shown by FIG. 1C, the buffer layer 150a may be disposed between the transmission lines 160 and the appearance decoration layer 130, between capacitive coupling pads of a capacitive coupling unit (such as pads 122a) and the appearance decoration layer 130, or between the touch-sensing element 120 and the substrate 110. Moreover, though not shown in the figures, the buffer layer 150a may be disposed between the first capacitive coupling unit 122 and the second capacitive coupling unit 124, between the touch-sensing element 120 and the protection layer 170, or to cover the touch-sensing element 120. The buffer layer 150a is allowed to change at least one mechanical property of a conjunction of neighbouring elements or a decorative cover plate to achieve beneficial effects. For example, in case the buffer layer 150a is interposed between the touch-sensing element 120 and the substrate 110, the buffer layer 150a may naturally serve as a cushion layer to resist impact knocking on the substrate 110, or the material characteristic of the buffer layer 150a may increase toughness of the combination of the touch-sensing element 120 and the substrate 110 to reduce the risk of break on suffering external impacts. Further, in case the buffer layer 150a and the substrate 110 are formed from different materials, it may open a possibility where surface adhesion of the buffer layer 150a is higher compared with the substrate 110 to develop a stronger attachment to the touch-sensing element 120 that is formed on and in contact with the buffer layer 150a.

Further, in case the buffer layer 150a is designed to have a selected range of refractive index, the buffer layer 150a may serve as an optical matching layer that matches with refractive indexes of adjacent layers in the transparent region 102 to improve the overall transmittance of a touch panel and reduce the visibility of a touch-sensing element. For example, the buffer layer 150a may be a dual-layer structure composed of silicon dioxide (SiO₂) and silicon nitride (SiNₓ), where the refractive index of the silicon nitride is higher than the refractive index of the silicon dioxide. In that case, reflection light from the buffer layer 150a and reflection light from the touch-sensing element 120 meet to cause interference effects and thus reduce a difference of refractive index between the touch-sensing element 120 and the insulation gaps 126. In one embodiment, in the light-shielding region 104, the touch-sensing element 120 may be disposed on one side of the light-shielding layer 140a facing away from the substrate 110, and the touch-sensing element 120 may not touch the appearance decoration layer 130, with the buffer layer 150a being interposed therebetween. In one embodiment, the buffer layer 150a may be disposed on a surface of the appearance decoration layer 130 facing away from the substrate 110, so that the touch-sensing element 120 may be formed on and in contact with the buffer layer 150a and the light-shielding layer 140a to prevent the touch-sensing element 120 from touching the appearance decoration layer 130. In that case, the touch-sensing element 120 is not patterned on the raised appearance decoration layer 130 to avoid the problem of insufficient etching or over-etching of a conductive material.

As shown in FIGS. 1B-1D, in an alternate embodiment, another buffer layer 190a is disposed between the appearance decoration layer 130 and the substrate 110 to provide additional effects, such as increasing the stability of the appearance decoration layer 130 on the substrate 110, adjusting the color hue of the appearance decoration layer 130, or changing at least one mechanical property of a decorative cover plate or a touch panel. In one embodiment, the material of the buffer layer 190a is different from the materials of the appearance decoration layer 130 and the substrate 110, and the appearance decoration layer 130 is surrounded by the buffer layer 190a and the buffer layer 150a. The buffer layer 190a may be formed from an insulation material including an organic material such as a photosensitive resin or a non-photosensitive resin, an inorganic insulation material, a mixture of organic and inorganic materials, or a hybrid compound of organic and inorganic materials. The buffer layer 190a formed from an organic material may have a thickness preferably in the range of 0.01 to 10 micrometers and a refractive index preferably in the range of 1.2 to 2. The buffer layer 190a formed from an inorganic dielectric material may include nitride or oxide, such as silicon oxide, titanium oxide, silicon nitride and titanium nitride, and have a thickness preferably in the range of 0.001 to 10 micrometers and a refractive index preferably in the range of 1.2 to 2. In an alternate embodiment, the buffer layer 150a and the buffer layer 190a may be formed from the same material.

As shown in FIG. 1B, in case the buffer layer 190a is formed from a transparent material, the buffer layer 190a may, except being disposed between the appearance decoration layer 130 and the substrate 110 in the light-shielding region 104, further spread over the transparent region 102 and between the touch-sensing element 120 and the substrate 110. In that case, the buffer layer 190a is allowed to change at least one mechanical property of a conjunction of neighbouring elements or a decorative cover plate to achieve beneficial effects, such as increasing the reliability and transmittance of a touch panel. For example, in case the buffer layer 190a is interposed between the touch-sensing element 120 and the substrate 110, the buffer layer 190a may naturally serve as a cushion layer to resist impact knocking on the substrate 110, or the material characteristic of the buffer layer 190a may increase toughness of the combination of the touch-sensing element 120 and the substrate 110 to reduce the risk of break on suffering external impacts. Further, in case the buffer layer 190a and the substrate 110 are formed from different materials, it may open a possibility where surface adhesion of the buffer layer 190a is higher compared with the substrate 110 to develop a stronger attachment to the touch-sensing element 120 that is formed on and in contact with the buffer layer 190a. In one embodiment, the buffer layer 190a may be a single-layer structure composed of silicon dioxide (SiO₂), so that the touch-sensing element 120 may be deposited on an insulating interface with less impurity to improve the reliability of a touch panel. In an alternate embodiment, the buffer layer 190a may be disposed only between the appearance decoration layer 130 and the substrate 110, as shown in FIG. 1C. Referring to FIG. 1D, the buffer layer 190a and the buffer layer 150a of the touch panel 100a″ may be both spread over the transparent region 102 and between the touch-sensing element 120 and the substrate 110. For example, the buffer layer 190a may be made of a high refractive index material, such as silicon nitride (SiNₓ), and the buffer layer 150a may be made of a low refractive index material, such as silicon dioxide (SiO₂).

In one embodiment, the buffer layer 190a may be a multi-layer structure including a silicon dioxide layer and a silicon nitride layer, where the refractive index of the silicon nitride layer is higher than the refractive index of the silicon dioxide layer, and the silicon nitride layer is closer to the substrate 110 compared with the silicon dioxide layer. In that case, the buffer layer 190a may be designed to have a selected range of refractive index, the buffer layer 190a may serve as an optical matching layer that matches with refractive indexes of the touch-sensing element 120 and the substrate 110 within the transparent region 102 to improve the overall transmittance of a touch panel and reduce the visibility of a touch-sensing element.

In one embodiment, any one of the appearance decoration layer 130, the light-shielding layer 140a, the buffer layer 150a and the buffer layer 190a that contains resin may further include polymer, and the polymer may be, for example, siloxane, polyimide, polyurethane, polycarbonate, polyethylene, polystyrene, polyvinylchloride, acrylic or epoxy.

The transmission lines 160 may be made of a conductive material such as metal, alloy, metallic stacked layers, alloy stacked layers or stacked layers of alloy and metal. The conductive material may be selected from, for example, chromium or chromium compounds, aluminium or aluminium compounds, silver or silver compounds, copper or copper compounds, gold or gold compounds, titanium or titanium compounds, tungsten or tungsten compounds, molybdenum or molybdenum compounds, zinc or zinc compounds, or alloy composed of the above-mentioned metals. For example, the transmission lines 160 may be formed from metallic stacked layers of molybdenum-aluminium-molybdenum.

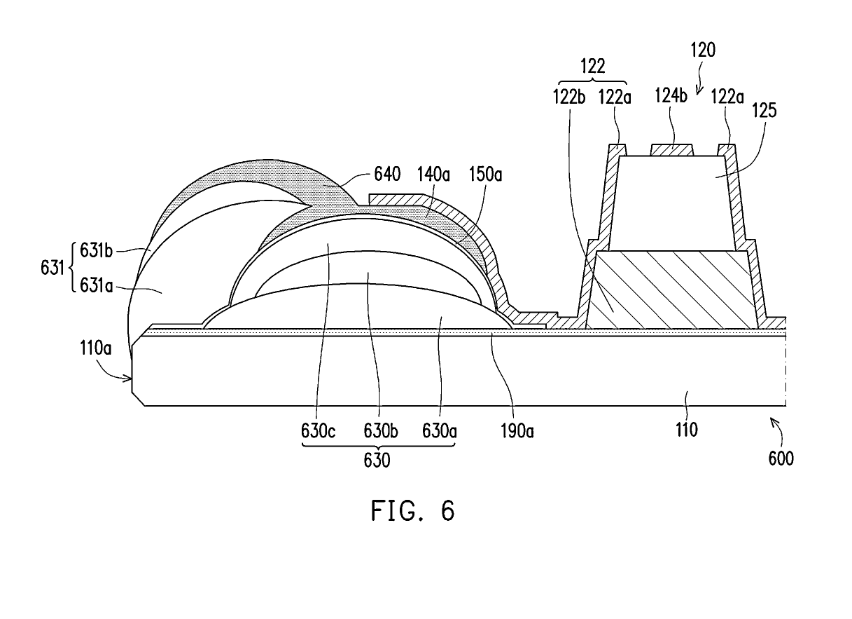

In one embodiment, as shown in FIG. 6, a touch panel 600 may further include a first border shielding layer 631 and a second border shielding layer 640 disposed on the substrate 110, and the first border shielding layer 631 is disposed between the second border shielding layer 640 and the substrate 110. An outer edge of the appearance decoration layer 630 keeps a distance away from an edge of the substrate 110. The appearance decoration layer 630 includes three stacked layers of white inks 630a, 630b and 630c. The first border shielding layer 631 including two stacked layers of white inks 631a and 631b may cover a part of the appearance decoration layer 630 and the edge of the substrate 110, and the second border shielding layer 640 covers a part of the first border shielding layer 631. In one embodiment, the first border shielding layer 631 or the second border shielding layer 640 may extend to cover a sidewall 110a of the substrate 110 to prevent the light from leaking out of the sidewalls 110a.

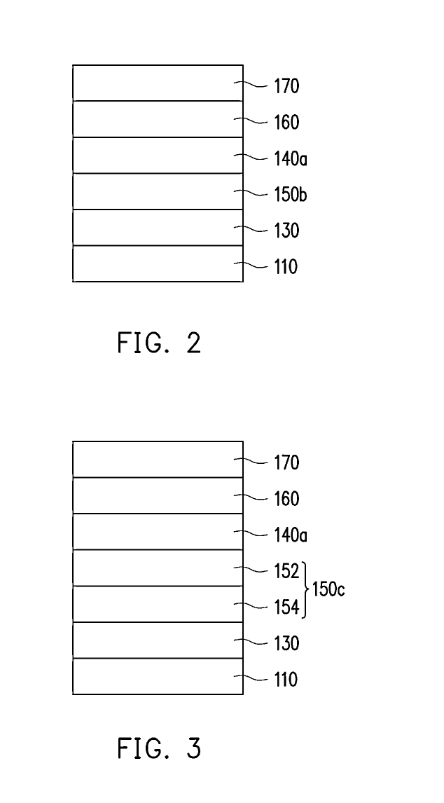

FIG. 2 is a diagram showing the stacked layers in the light-shielding region of a touch panel according to an embodiment of the invention. In this embodiment, the buffer layer 150b is made of a light-transmitting material given a color to reduce the color-shift imposed on the appearance decoration layer 130 as a result of the light-shielding layer 140a and to modify the displayed color of the appearance decoration layer 130. For example, a white organic resin material may be disposed between the appearance decoration layer 130 formed from white photoresist and the light-shielding layer 140a formed from black ink to form the buffer layer 150b. In this way, the overall thickness of a white material is increased to improve the brightness and reduce the color shift on the appearance decoration layer 130.

FIG. 3 is a diagram showing the stacked layers in the light-shielding region of a touch panel according to another embodiment of the invention. In this embodiment, the buffer layer 150c is a dual-layer structure composed of a buffer layer 152 made of a transparent insulation material and a buffer layer 154 made of a light-transmitting insulation material given a color. The buffer layer 152 made of a transparent insulation material is located between the light-shielding layer 140a and the appearance decoration layer 130, and the buffer layer 154 made of a light-transmitting insulation material is located between the buffer layer 152 and the appearance decoration layer 130. Accordingly, the influence of the light-shielding layer 140a on the buffer layer 154 is reduced to allow the buffer layer 154 to more stably modify the displayed color of the appearance decoration layer 130 and prevent the light-shielding layer 140a from affecting the displayed color of the appearance decoration layer 130. However, a stacking sequence of the buffer layer 152 and the buffer layer 154 is not limited. In an alternate embodiment, the stacking sequence of the buffer layer 154 and the buffer layer 152 shown in FIG. 3 may be reversed.

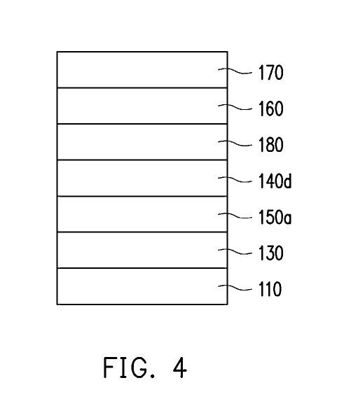

FIG. 4 is a diagram showing the stacked layers in the light-shielding region of a touch panel according to another embodiment of the invention. In this embodiment, the light-shielding layer 140d is formed from metal or metallic compounds, and the thickness of the light-shielding layer 140d formed from metal or metallic compounds may be in the range of 0.05 to 0.5 micrometers. Since the light-shielding layer 140d is electrically conductive in this embodiment, an insulation layer 180 is added to interpose between the light-shielding layer 140d and the transmission lines 160 to avoid short circuiting.

According to the above embodiments, the buffer layer is allowed to change at least one mechanical property of a conjunction of neighbouring elements or a decorative cover plate to achieve beneficial effects. For example, in case the buffer layer is interposed between the touch-sensing element and the substrate, the buffer layer may naturally serve as a cushion layer to resist impact knocking on the substrate, or the material characteristic of the buffer layer may increase toughness of a combination of the touch-sensing element and the substrate to reduce the risk of break on suffering external impacts. Further, in case the buffer layer and the substrate are formed from different materials, it may open a possibility where surface adhesion of the buffer layer is higher compared with the substrate to develop a stronger attachment to the touch-sensing element that is formed on and in contact with the buffer layer. Besides, in case the buffer layer is designed to have a selected range of refractive index, the buffer layer may serve as an optical matching layer that matches with refractive indexes of adjacent layers in the transparent region to improve the overall transmittance of the touch panel and reduce the visibility of the touch-sensing element. Moreover, the coverage of the appearance decoration layer and the light-shielding layer may define a light-shielding region of the touch panel, and a buffer layer may be disposed between an appearance decoration layer and a light-shielding layer to reduce the influence of the light-shielding layer on the appearance decoration layer. Therefore, the displayed color of the light-shielding region may have improved color saturation. In addition, the appearance decoration layer enables the touch panel to show a specific color, and the light-shielding layer may provide light-shielding effects to hide an element intended to be invisible to a user. Therefore, the touch panel is allowed to have a wide diversity of appearances to satisfy individual needs of consumers.

It will be apparent to those skilled in the art that the descriptions above are several preferred embodiments of the invention only, which does not limit the implementing range of the invention. Various modifications and variations may be made to the structure of the invention without departing from the scope or spirit of the invention. The claim scope of the invention is defined by the claims hereinafter.

What is claimed is:

1. A touch panel, comprising:
a substrate;
an appearance decoration layer disposed on a periphery of the substrate;
a touch-sensing element disposed on the substrate and comprising:
a plurality of first capacitive coupling units, wherein each of the first capacitive coupling units comprises multiple first pads and multiple first connection lines, the first pads are connected with each other by the first connection lines, and at least one of the first pads overlaps the appearance decoration layer;
a plurality of second capacitive coupling units spaced apart from the first capacitive coupling units, wherein the second capacitive coupling units and the first capacitive coupling units are oriented to cross over each other at crossover locations, each of the second capacitive coupling units comprises multiple second pads and multiple second connection lines, the second pads are connected with each other by the second connection lines, and at least one of the second pads overlaps the appearance decorative layer; and
a plurality of insulators separate from each other, wherein the insulators are disposed in the crossover locations to separate the first capacitive coupling units and the second capacitive coupling units at each of the crossover locations;
a plurality of transmission lines disposed on the substrate, shielded by the appearance decoration layer, and electrically connected to the touch-sensing element; and
a buffer layer formed on the substrate and at least interposed between the touch-sensing element and the substrate to change at least one mechanical property of a combination of the touch-sensing element and the substrate.

2. The touch panel as claimed in claim 1, wherein a part of the buffer layer is located between the transmission lines and the appearance decoration layer.

3. The touch panel as claimed in claim 1, where the buffer layer is an optical matching layer with a refractive index matching with a refractive index of the touch-sensing element.

4. The touch panel as claimed in claim 1, further comprising:
a light-shielding layer disposed on one side of the appearance decoration layer facing away from the substrate, wherein an optical density of the light-shielding layer is greater than an optical density of the appearance decoration layer.

5. The touch panel as claimed in claim 1, wherein the buffer layer is formed from an organic material, a mixture of organic and inorganic materials, or a hybrid compound of organic and inorganic materials.

6. The touch panel as claimed in claim 1, wherein a part of the buffer layer is located between and in contact with the appearance decoration layer and the substrate.

7. The touch panel as claimed in claim 1, wherein the buffer layer has a first part disposed on a first side of the appearance decoration layer and a second part disposed on a second side of the appearance decoration layer opposite the first side, and the first part and the second part are formed from mutually different materials.

8. A touch panel, comprising:
a substrate;
a buffer layer formed on and in contact with the substrate, wherein the buffer layer and the substrate are formed from mutual different materials to have different surface adhesions;
an appearance decoration layer disposed on a periphery of the substrate;
a touch-sensing element formed on and in contact with the buffer layer, wherein the touch-sensing element comprises a plurality of capacitive coupling pads, and at least one of the capacitive coupling pads covers a part of the appearance decoration layer; and
a plurality of transmission lines disposed on the appearance decoration layer and electrically connected to the touch-sensing element.

9. The touch panel as claimed in claim 8, wherein a part of the buffer layer is located between the transmission lines and the appearance decoration layer.

10. The touch panel as claimed in claim 8, where the buffer layer is a transparent insulation layer, and a refractive index of the buffer layer is different to refractive indexes of the substrate and the touch-sensing element.

11. The touch panel as claimed in claim 8, further comprising:
a light-shielding layer disposed on one side of the appearance decoration layer facing away from the substrate, wherein an optical density of the light-shielding layer is greater than an optical density of the appearance decoration layer.

12. The touch panel as claimed in claim 8, wherein the buffer layer is formed from an organic material, a mixture of organic and inorganic materials, or a hybrid compound of organic and inorganic materials.

13. The touch panel as claimed in claim 1, wherein a part of the buffer layer is located between and in contact with the appearance decoration layer and the substrate.

14. The touch panel as claimed in claim 1, wherein the buffer layer substantially surrounds the appearance decoration layer.

15. A touch panel, comprising:
a substrate;
a buffer layer formed on and in contact with the substrate, wherein the buffer layer comprises organic material;
an appearance decoration layer disposed on a periphery of the substrate;
a touch-sensing element formed on and in contact with the buffer layer, wherein the touch-sensing element comprises:
a plurality of first capacitive coupling units, wherein each of the first capacitive coupling units comprises multiple first pads and multiple first connection lines, the first pads are connected with each other by the first connection lines, and at least one of the first pads overlaps the appearance decoration layer;
a plurality of second capacitive coupling units spaced apart from the first capacitive coupling unit, wherein the second capacitive coupling unit and the first capacitive coupling unit are oriented to cross over each other at crossover locations, each of the second capacitive coupling unit comprises multiple second pads and multiple second connection lines, the second pads are connected with each other by the second connection lines, and at least one of the second pads overlaps the appearance decorative layer; and
a plurality of insulators separate from each other, wherein the insulators are disposed in the crossover locations to separate the first capacitive coupling units and the second capacitive coupling units; and
a plurality of transmission lines disposed on the appearance decoration layer and electrically connected to the touch-sensing element.

16. The touch panel as claimed in claim 15, wherein at least one of the first pads covers a part of one of the insulators.

17. The touch panel as claimed in claim 15, wherein a lateral side of at least one of the insulators is not aligned with a lateral side of one of the first connection lines under the insulator to expose a part of the first connection line, and one of the first pads covers the exposed part of the first connection line and touches the lateral side of the insulator, the lateral side of the first connection line, and the exposed part of the first connection line.

18. The touch panel as claimed in claim 15, wherein a part of the buffer layer is located between the transmission lines and the appearance decoration layer.

19. The touch panel as claimed in claim 15, further comprising:
a light-shielding layer disposed on one side of the appearance decoration layer facing away from the substrate, wherein an optical density of the light-shielding layer is greater than an optical density of the appearance decoration layer.

20. The touch panel as claimed in claim 15, wherein a part of the buffer layer is located between and in contact with the appearance decoration layer and the substrate.
